(19) United States
(12) Patent Application Publication
(10) Pub. No.: US 2004/0240687 A1
(43) Pub. Date: Dec. 2, 2004

(54) Flat panel speaker

(76) Inventor: Michael L. Graetz, Stillwater, MN (US)

Correspondence Address: 3M INNOVATIVE PROPERTIES COMPANY, PO BOX 33427, ST. PAUL, MN, 55133-3427, US

(21) Appl. No.: 10/449,497

(22) Filed: May 30, 2003

(51) Int. Cl. H04R 9/06; H04R 25/00; H04R 11/02

(52) U.S. Cl. 381/152; 381/431

(57) ABSTRACT

This disclosure is directed to flat panel speakers in which an exciter is mounted at a non-zero angle relative to a flat panel. For example, a mounting bracket can be attached to the flat panel, and the exciter can be mounted on the mounting bracket such that the exciter is rotated at relative to the flat panel. By mounting the exciter at a non-zero angle relative to the flat panel, less surface area of the flat panel is consumed by the presence of the exciter. Accordingly, flat panel speaker designs as described in this disclosure are particularly useful when the surface are of the flat panel is also used for other purposes.

### TECHNICAL FIELD

This disclosure relates to audio speakers and, more particularly, to flat panel speakers.

### BACKGROUND

Flat panel speakers refer to speakers that make use of a flat panel and an exciter positioned on the panel. In general, the exciter produces vibrations that are distributed through the flat panel to excite the flat panel into complex bending modes. For example, the exciter may comprise a voice coil and can be driven by a power amplifier to produce the vibrations that excite the flat panel. By distributing the output of the exciter through the panel, high fidelity sound can be produced. One example of a flat panel speaker is a distributed mode loudspeaker (DML).

### SUMMARY

In general, this disclosure is directed to a flat panel speaker in which an exciter is mounted at a non-zero angle relative to a flat panel. A mounting bracket, for example, can be attached to the flat panel, and the exciter can be mounted on the mounting bracket such that the exciter is angled relative to a major plane of the flat panel. By mounting the exciter at a non-zero angle relative to the flat panel, less surface area of the flat panel is consumed by the presence of the exciter. Accordingly, a flat panel speaker, as described in this disclosure, is particularly useful when the surface area of the flat panel is also used for other purposes. For example, a flat panel speaker, as described herein, may be particularly useful as rear projection screens for flat panel displays, computer screens, computer screen filters, protective covers for displays, electromagnetic interference (EMI) filter panels, liquid crystal display (LCD) backlight diffuser panels, plasma display screens, LCD display screens, and the like.

In one embodiment, this disclosure provides a flat panel speaker comprising a flat panel, and an exciter mounted to the flat panel such that an output surface of the exciter is oriented at a non-zero angle relative to a major surface of the flat panel. For example, a bracket can be used to mount the exciter to the flat panel such that an output surface of the exciter is oriented at a non-zero angle relative to a major surface of the flat panel, although this disclosure is not necessarily limited in that respect.

In another embodiment, this disclosure provides a system comprising a flat panel speaker including a flat panel, and an exciter mounted to the flat panel such that an output surface of the exciter is oriented at a non-zero angle relative to a major surface of the flat panel. The system further comprises a driver unit electrically coupled to the exciter to drive the exciter.

In another embodiment, this disclosure provides a flat panel speaker comprising a flat panel, an exciter defining an output surface, and means for mounting the exciter on the flat panel such that the output surface of the exciter is oriented at a non-zero angle relative to a major surface of the flat panel.

In another embodiment, this disclosure provides a flat panel display system comprising a flat panel display screen, a projection unit for projecting images on the flat panel display screen, a bracket attached to the flat panel, an exciter mounted on the bracket such that an output surface of the exciter is oriented at a non-zero angle relative to a major surface of the flat panel, and a driver unit electrically coupled to the exciter to drive the exciter.

The details of one or more embodiments of this disclosure are set forth in the accompanying drawings and the description below. Other features, objects, and advantages of this disclosure will be apparent from the description and drawings, and from the claims.

### BRIEF DESCRIPTION OF DRAWINGS

FIG. 1 is a perspective view of a system including a conventional flat panel speaker electrically coupled to a driver unit.

FIG. 2 is a side view of the conventional flat panel speaker of FIG. 1.

FIG. 3 is a side view of a flat panel speaker according to an embodiment of this disclosure.

FIG. 4 is a conceptual side view of flat panel speaker system including a flat panel speaker electrically coupled to a driver unit according to an embodiment of this disclosure.

FIGS. 5-10 are side views of flat panel speakers according to embodiments of this

FIG. 11 is a top view of a flat panel rear projection display system making use of a flat panel speaker design according to an embodiment of this disclosure.

FIGS. 12-14 are side views of flat panel speakers according to embodiments of this disclosure.

### DETAILED DESCRIPTION

This disclosure is directed to flat panel speakers in which an exciter is mounted at a non-zero angle relative to a major plane of a flat panel, i.e., a positive angle. For example, a mounting bracket can be attached to the flat panel, and the exciter can be mounted on the mounting bracket such that an output surface of the exciter is angled relative to a surface of the flat panel. By mounting the exciter at a non-zero angle relative to the flat panel, less surface area of the flat panel is consumed by the presence of the exciter. Moreover, reduced consumption of flat panel surface area provides more room to use the flat panel for other purposes. Accordingly, flat panel speaker designs as described in this disclosure are particularly useful when the surface area of the flat panel is also used for other purposes.

One example of such an application where the surface area of the flat panel speaker is also used for another purpose is a rear-projection screen in a flat panel display. In that case, the projection screen of the display may also function as a flat panel speaker. One or more exciters can be mounted near an outer edge of the projection screen such that the useful part of the screen, i.e., the portion used for projection of images, is increased relative to a screen that has exciters conventionally mounted on the screen. The size of bezels of the flat panel display may be reduced as well, Accordingly, the teaching of this disclosure can be used to increase the useful size of a rear-projection screen in a flat panel display when the screen is also used as a flat panel speaker. Numerous other flat panel speaker applications also exist where the surface area of the flat panel speaker is also used for other purposes, including computer screen applications, computer screen filters, protective covers for displays, EMI filter panels, LCD backlight diffuser panels, plasma display screens, LCD display screens, and the like. This disclosure may be particularly useful for these and other applications by reducing the amount of surface area of the flat panel that is consumed by the presence of the exciter.

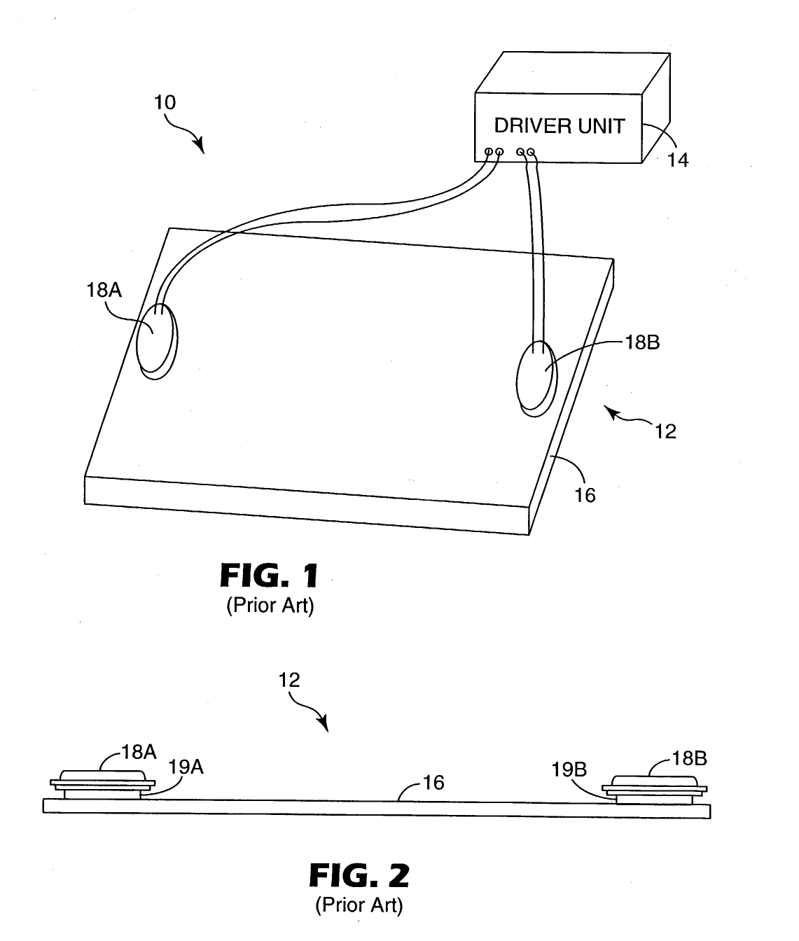

FIGS. 1 and 2 are illustrations of the prior art flat panel speakers. FIG. 1 is a perspective view of a system 10 including a conventional flat panel speaker 12 electrically coupled to a driver unit 14. FIG. 2 is a side view of conventional flat panel speaker 12. Flat panel speaker 12 includes a flat panel 16 and one or more exciters 18A, 18B (collectively exciters 18) positioned on flat panel 16. In accordance with the prior art, output surfaces 19A, 19B abut a major surface of flat panel 16, and are substantially parallel to the flat panel major surface. In other words, in accordance with the prior art, output surfaces 19A, 19B define an angle of zero relative to the major surface of flat panel 16.

Exciters 18 produce vibrations that are distributed through flat panel 16 to excite flat panel 16 into complex bending modes. In particular, driver unit 14 drives exciters 18 to cause exciters 18 to produce the vibrations that excite flat panel 16. Exciters 18 comprise a voice coil and driver unit 14 includes a power amplifier that drives exciters 18. By distributing the output of exciters 18 through flat panel, high fidelity sound can be produced. Exciters 18 typically comprise voice coils.

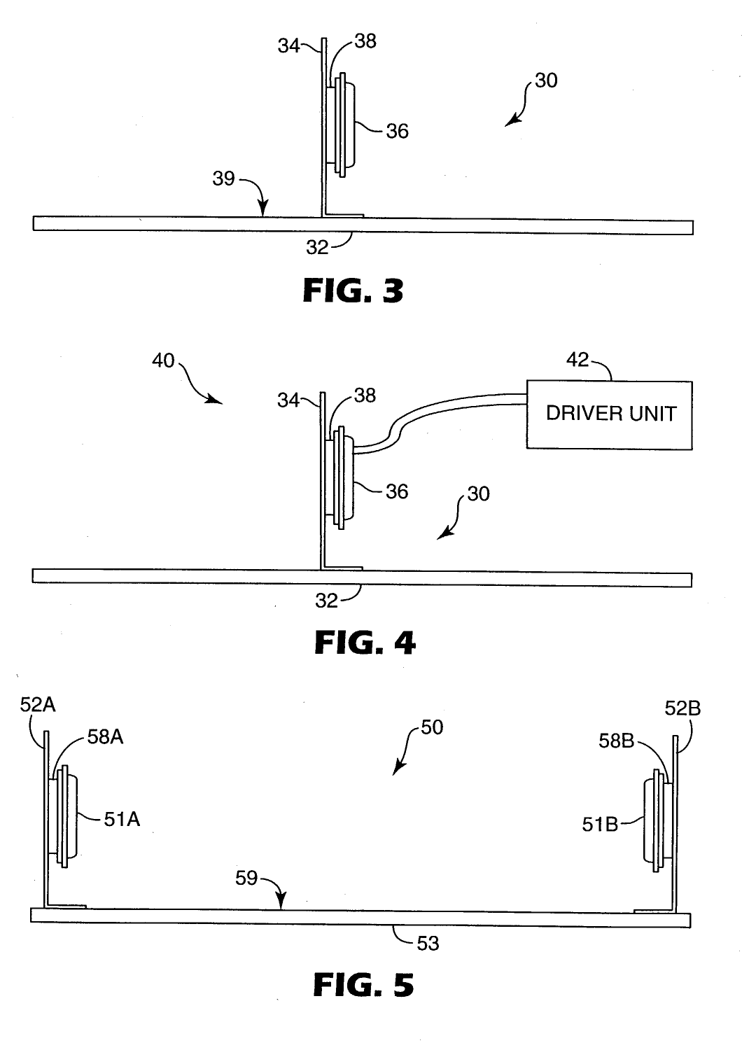

FIG. 3 is a side view of a flat panel speaker 30 according to an embodiment of this disclosure. As shown in FIG. 3, flat panel speaker 30 includes a flat panel 32 and a bracket 34 attached to the flat panel. Flat panel speaker 30 also includes an exciter 36 that defines an output surface 38. In accordance with this disclosure, exciter 36 is mounted on bracket 34 such that output surface 38 of exciter 36 is oriented at a non-zero angle relative to a major surface 39 of flat panel 32, e.g., a positive angle. In this example, output surface 38 of exciter 36 is oriented relative to major surface 39 of flat panel 32 at an angle of approximately 90 degrees. V

In other words, output surface 38 is positioned at approximately a right angle relative to major surface 39. Bracket 34 facilitates such positioning, although other structures could be used as well. Output surface 38 of exciter 36 is mounted adjacent a first surface of bracket 34 and a second surface of bracket 34 attaches to flat panel 32, e.g., using adhesives, screws, or other fixation mechanisms. By mounting exciter 36 at a non-zero angle relative to flat panel 32, less surface area of flat panel 32 is consumed by the presence of exciter 36.

Flat panel 32 may comprise a rigid, yet bendable material, such as an acrylic, polycarbonate, or the like. Glass or other materials may also be used to realize flat panel 32. Flat panel 32 may define an area in the range of 0.001 square meter to 10 square meters, although this disclosure is not limited in that respect. In some cases, the major surface of flat panel 32 may be arced, curved or slightly bent in order to conform flat panel 32 to a desirable shape for a given application.

Exciter 36 typically comprises a voice coil, but may take other forms such as a piezoelectric element, or the like. Output surface 38 of exciter 36 may define an area in the range of 0.6 square centimeter to 65 square centimeters Accordingly, the surface of bracket 34 to which output surface attaches may define an area in the range of 1 square centimeter to 130 square centimeters in order to accommodate mounting of exciter 36 on bracket 34.

FIG. 4 is a conceptual side view of flat panel speaker system 40 including flat panel speaker 30 electrically coupled to driver unit 42. Exciter 36 produces vibrations that are distributed through flat panel 32 to excite flat panel 32 into complex bending modes. In particular, driver unit 42 drives exciter 36 to cause output surface 38 of exciter 36 to produce the vibrations that excite flat panel 32. The vibrations are transferred through bracket 34 and distributed through flat panel 32 to produce high fidelity sound.

Exciter 36 typically comprises a voice coil, and driver unit 42 includes a power amplifier that drives exciter 36. As described in greater detail below, bracket 34 can be formed of a material that facilitates good vibrational transfer to flat panel 32. In particular, bracket 34 can be formed of a material with a high specific modulus as discussed in greater detail below. A relatively low-density, rigid material for bracket 34 can facilitate good vibrational transfer to flat panel 32.

Exciter 36 may comprise any flat panel exciter such as those commercially available from ELAC Electroacustic GmbH of Germany, Fane Acoustics Limited of England, Zhejiang Tianle Group Corp. of China, or other suitable exciter manufacturers, such as manufacturers licensed by NXT plc company of the United Kingdom. Driver unit 42 may comprise any power amplifier, or the like, that can be used to drive speakers in order to produce sound.

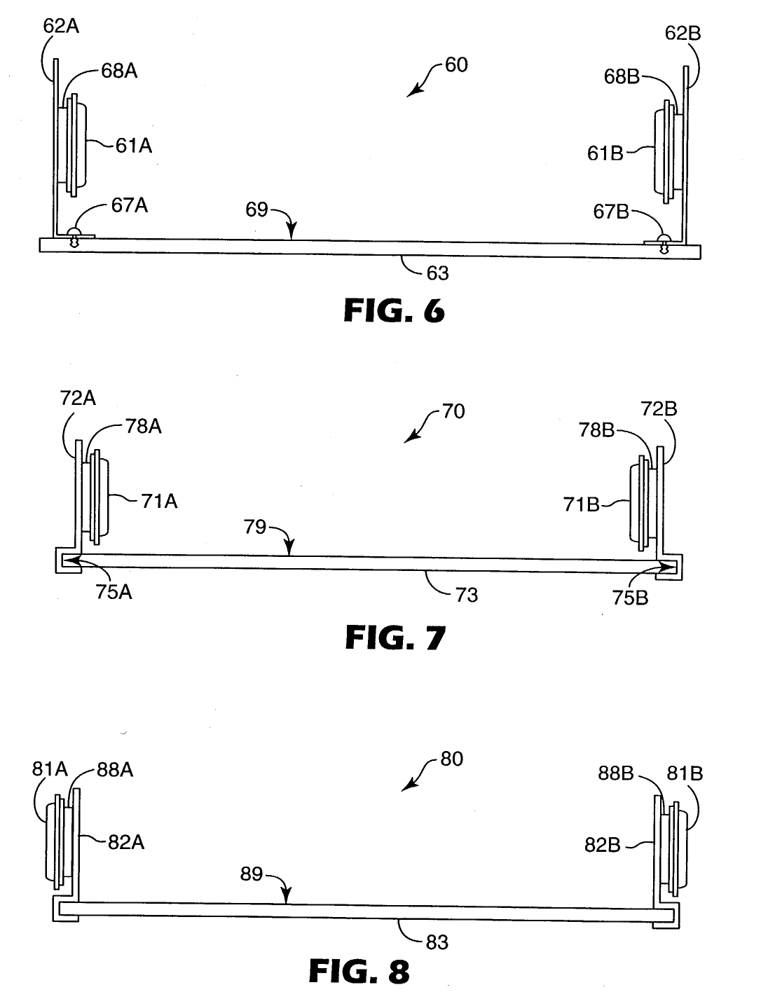

In different embodiments, any number of exciters can be used in the flat panel speaker, and thus any number of brackets can be used to orient the respective exciters at angles relative to the major surface of the flat panel. FIGS. 5 and 6 are side views of flat panel speakers 50, 60 that each include a plurality of exciters Specifically speaker 50 (FIG. 5) includes exciters 5.1A, 51B mounted on brackets 52A, 52B and speaker 60 (FIG. 6) includes exciters 61A, 61B mounted on brackets 62A, 62B.

As described herein, exciters 51A, 51B are mounted on brackets 52A, 52B such that output surfaces 58A, 58B of exciters 51A, 51B are oriented at non-zero angles relative to the major surface 59 of flat panel 53. Similarly, as shown in FIG. 6, exciters 61A, 61B are a mounted on brackets 62A, 62B such that output surfaces 68A, 68B of exciters-61A, 61B are oriented at non-zero angles relative to the major surface 69 of flat panel 63. In the examples of FIGS. 5 and 6 the brackets are positioned near the edges of the respective flat panels. Accordingly, the area between the brackets can be used for other purposes. For example, flat panels 53, 63 may comprise projection screens for a rear-projection flat panel display system, protective elements of a computer display screen, filters of a computer screen, EMI filter panels, liquid crystal display (LCD) backlight diffuser panels, plasma display screens, LCD display screens, or the like.

An adhesive can be used to mount the respective exciters on the brackets. For example, a pressure sensitive adhesive, an epoxy, or the like, may be used to affix the respective exciters on the brackets. Preferably, the adhesive used to mount the exciters on, the brackets should be stiff, having little compliance. Such a stiff adhesive can help ensure that the vibrational output of the exciters is transferred to the respective flat panel, via the brackets, without being substantially absorbed or dampened by the adhesive.

In the example illustrated in FIG. 5, brackets 52A, 52B are mounted on flat panel 53 via an adhesive. A pressure sensitive adhesive, an epoxy or the like may be used to affix brackets 52A, 52B to flat panel 53. Like the adhesive used to mount exciters 51A, 51B on brackets 52A, 52B the adhesive used to affix brackets 52A, 52B to flat panel 53 is preferably a stiff adhesive to help ensure that the vibrational output of exciters 51A, 51B is transferred to flat panel 53 via brackets 52A, 52B without being substantially absorbed or dampened by the adhesives. Importantly, the adhesive should not absorb or dampen the vibrational output of exciters 51A, 51B. Advantages of using a pressure sensitive adhesive include simplicity of application, conformity to rough surfaces, and resistance to cracking if the adhered surface is flexed.

In the example illustrated in FIG. 6, brackets 62A, 62B are mounted on flat panel 63 via mechanical elements 67A, 67B, such as bolts, screws, dowels, or the like. In any case, a tight bond between exciters 61A, 61B and brackets 62A, 62B and a tight bond between brackets 62A, 62B and flat panel 63 can help ensure that the vibrational output of exciters 61A, 61B is transferred to flat panel 63 to produce high fidelity sound.

FIG. 7 is a side view of another flat panel speaker 70 in which exciters 71A, 71B are; mounted on brackets 72A, 72B such that output surfaces 78A, 78B of exciters 71A, 71B are oriented at non-zero angles relative to the major surface 79 of flat panel 73. In the example of FIG. 7, brackets 72A, 72B are attached to the edges of flat panel 73. Accordingly, the area between brackets 72A, 72B can be used for other purposes.

Brackets 72A, 72B define substantially U-shaped lips 75A, 75B that mate with edges of flat panel 73. In this manner, assembly of flat panel speaker 70 can be simplified. The U-shaped lips 75A, 75B of brackets 72A, 72B can affix to the edges of flat panel 73 via an adhesive, and the adhesive is preferably stiff to help ensure that the vibrational output of exciters 71A, 71B is transferred to flat panel 73. Alternatively, brackets 72A, 72B may be crimped to the edges of flat panel 73, or affixed by some other mechanism.

FIG. 8 is a side view of a flat panel speaker 80 similar to flat panel speaker 70 of FIG. 7. As shown, in FIG. 8, exciters 801A, 81B are mounted on brackets 82A, 82B such that output surfaces 88A, 88B of exciters 81A, 81B are oriented at non-zero angles relative to the major surface 89 of flat panel 83. In particular, the exciters can be mounted on either side of the brackets as shown in FIGS. 7 and 8 collectively.

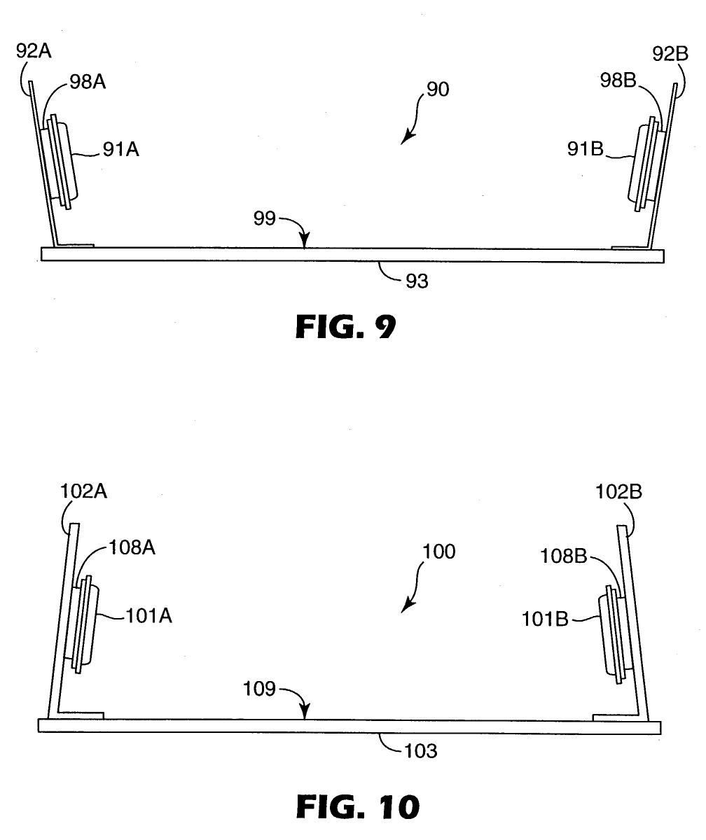

FIG. 9 is a side view of another flat panel speaker 90, in which exciters 91A, 91B are mounted on brackets 92A, 92B such that output surfaces 98A, 98B of exciters 91A, 91B are oriented at non-zero angles relative to the major surface 99 of flat panel 93. In the example of FIG. 9, the angles defined by output surfaces 98A, 98B relative to major surface 99 are obtuse angles.

FIG. 10 is a side view of another flat panel speaker 100 in which exciters 101A, 101B are mounted on brackets 102A, 102B such that output surfaces 108A, 108B of exciters 101A, 101B are oriented at angles relative to the major surface 109 of flat panel 103. In the example of FIG. 10, the angles defined by output surfaces 108A, 108B relative to major surface 109 are acute angles.

In accordance with this disclosure, the angles defined by output surfaces of the exciters relative to the major surface of the flat panel may fall within a range approximately between 45 degrees and 135 degrees. For example, the bracket can define an angle greater than approximately 45 degrees and less than approximately 135 degrees such that when the exciter is mounted on the bracket and the bracket is mounted on the flat panel, the output surfaces of the exciter relative to the major surface of the flat panel assumes the angle defined by the bracket.

In many cases, the output surface of the exciter is mounted relative to the major surface of the flat panel at an angle of approximately 90 degrees, such as illustrated in FIGS. 3-8. In that case; the bracket typically defines aright angle. In any case, angular mounting of the, excites relative to the flat panel can cause less surface area of the flat panel to be consumed by the presence of the exciters. Use of brackets defining right angles generally minimizes the amount of surface area consumed by the presence of the exciters. Flat panel speaker designs of this disclosure may be particularly useful when the surface are of the flat panel is also used for other purposes, such as a display screen of a rear-projection flat panel display.

As mentioned above, one factor that can affect performance of the flat panel speakers described herein is the material composition of the brackets used to position the exciters at angles relative to the surface of the flat panel. In general, it is desirable to form the brackets of a very stiff yet light material in order to ensure a high percentage of vibrational energy transfer between the exciter and the flat panel, via the bracket. Cost may also be a factor.

In accordance with this disclosure, it was experimentally determined that aluminum works well for a low cost bracket. High tensile steel also works relatively well. For higher efficiency energy transfer, carbon fiber composite brackets may be used. Table 1 lists various materials and the density, modulus (in units of giga pascal [Gpa]), and specific modulus for each material (in units of modulus per density, or Gpa/gram/cm³). The modulus refers to a quantification of stiffness and the specific modulus refers to the modulus divided by the density of the respective material.

In accordance with this disclosure, it was determined that brackets made of a material having a high specific modulus achieve improved energy transfer between the exciter and the flat panel. In other words, brackets made of materials having a higher specific modulus are generally more desirable that brackets made of material having lower specific modulus for the applications described herein. Table 1 lists various materials and the density, modulus and specific modulus for each material.

TABLE 1

| | | | SPECIFIC |
|---|---|---|---|
| | DENSITY | MODULUS | MODULUS |
| MATERIAL | (g/cm³) | (Gpa) | (Gpa/g/cm³) |
| Polycarbonate | 1.20 | 2.4 | 2.0 |
| Acrylic | 1.19 | 3.4 | 2.9 |
| Fiberglass reinforced epoxy | 2.60 | 32 | 12 |
| 80% glass | | | |
| titanium | 4.54 | 116 | 26 |
| 6030-T6 Aluminum | 2.70 | 70 | 26 |
| AISI 1065 High Tensile Steel | 7.85 | 210 | 27 |
| Soda Lime Float Glass | 2.47 | 70 | 28 |
| Kevlar Epoxy Composite | 1.44 | 131 | 91 |
| Beralcast 191 Beryllium- | 2.16 | 200 | 93 |
| Aluminum | | | |
| Thornel 55 Carbon Epoxy | 1.70 | 220 | 129 |
| Composite | | | |
| Thornel 120 Carbon Epoxy | 2.16 | 520 | 241 |
| Composite | | | |

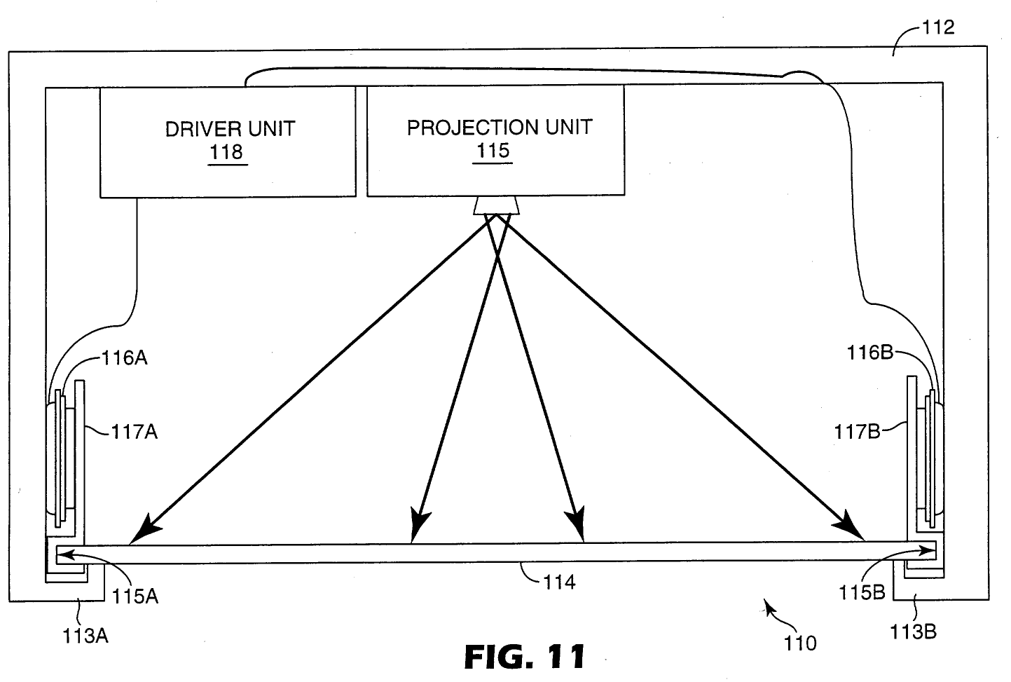

FIG. 11 is a top view of a flat panel rear projection display system 1110 making use of a flat panel speaker design according to an embodiment of this disclosure. Flat panel rear projection display system 110 includes a housing 112 and a flat panel 114 that forms a front wall of housing 112. Housing 112 defines bezels 113A, 113B that overlap the edges of flat panel 114. Within housing 112 is a projection unit 115 that projects images onto flat panel 114. Also disposed Within housing, 112 are exciters 116A and 116B which are driven by driver unit 118.

In accordance with this disclosure, exciters 116A, 116B are mounted on brackets 117A, 117B and brackets 117A, 117B are mounted on flat panel 114 according to one of the embodiments described herein. In the illustrated example of FIG. 11, brackets 117A, 117B define U-shaped lips 115A, 115B that are adhesively fixed to the edges of flat panel 114, similar to the embodiments described above with reference to FIGS. 7 and 8. Exciters 116A and 116B are adhesively fixed to brackets 117A, 117B and may also be adhesively fixed to the inner surfaces of housing 112.

By mounting exciters 116A, 116B at non-zero angles relative to flat panel 114, less surface area of flat panel 114 is consumed by the presence exciters 116A, 116B. Thus, the area of flat panel 14 useful for display of images projected by projection unit 115 is increased relative to systems in which the exciters are mounted directly on the flat panel as illustrated in prior art FIGS. 1 and 2. Also, in accordance with the teaching of this disclosure, the size of bezels 113A, 113B can also be reduced relative to conventional flat panel speaker assemblies.

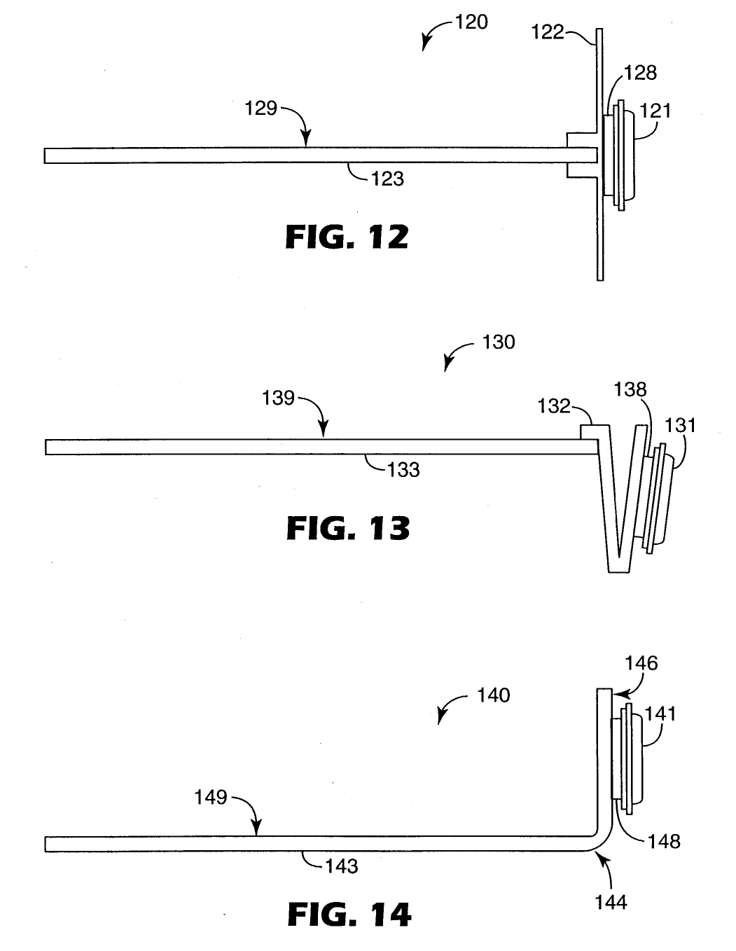

FIG. 12 is a side view of another flat panel speaker 120 in which an exciter 121 is mounted on bracket 122 such that output surface 128 of excite 121 is oriented at an angle relative to the major surface 129 of flat panel 123. In the example of FIG. 12, bracket 122 comprises a T-shape bracket that is mounted to the edge of flat panel 123, e.g., via an adhesive or mechanical attachment element.

FIG. 13 is a side view of another flat panel speaker 130 in which an exciter 131 is mounted on bracket 132 such that output surface 138 of exciter 131 is oriented at an angle relative to the major surface 139 of flat panel 133. In the example of FIG. 13, bracket 132 comprises a V-shape bracket that is mounted to the edge of flat panel 133, e.g., via an adhesive or mechanical attachment element. Such a V-shaped bracket 132 may improve transfer of vibrations from exciter 131 to flat panel 133 relative to other shaped brackets.

FIG. 14 is a side view of another, flat panel speaker 140 in which an exciter 141 is mounted to flat panel 143 such that output surface 148 of exciter 141 is oriented at an angle relative to the major surface 149 of flat panel 143. In the example of FIG. 14, flat panel 143 is formed with a bend 144, in order to define minor surface 146. Exciter 141 is mounted on minor surface 146 of flat panel 143 such that output surface 148 of exciter 141 is oriented at an angle relative to the major surface 149 of flat panel 143. In other words, flat panel 143 is L-shaped to define major surface 149 and minor surface 146, with exciter 141 being mounted on minor surface 146.

A number of embodiments have been described. For example, flat panel speaker designs have been described in which a mounting bracket facilitates mounting of the flat panel exciter at a non-zero angle relative to the flat panel. Nevertheless, various modifications can be made without departing from the spirit and scope of the disclosure. These and other embodiments are within the scope of the following claims.

1. A flat panel speaker comprising:
a flat panel; and
an exciter mounted to the flat panel such that an output surface of the exciter is oriented at a non-zero angle relative to a major surface of the flat panel.

2. The flat panel speaker of claim 1, wherein the output surface of the exciter is mounted relative to the major surface the flat panel at an angle between approximately 45 degrees and 135 degrees.

3. The flat panel speaker of claim 2, wherein the output surface of the exciter is mounted relative to the major surface of the flat panel at an angle of approximately 90 degrees.

4. The flat panel speaker of claim 1, further comprising a bracket, wherein the output surface of the exciter is mounted to the bracket and the bracket attaches to the flat panel.

5. The flat panel speaker of claim 4, wherein the output surface of the exciter is mounted adjacent a surface of the bracket via an adhesive.

6. The flat panel speaker of claim 5, wherein the bracket attaches to the flat panel via another adhesive.

7. The flat panel speaker of claim 5, wherein the bracket attaches to the flat panel via a mechanical attachment element.

8. The flat panel speaker of claim 4, wherein the bracket comprises an L-shaped bracket.

9. The flat panel speaker of claim 4, wherein the bracket defines a substantially U-shaped lip that mates with an edge of the flat panel.

10. The flat panel speaker of claim 9, wherein the edge of the flat panel attaches to the bracket in the U-shaped lip via an adhesive.

11. The flat panel speaker of claim 4, wherein the bracket attaches to the flat panel near an edge of the flat panel.

12. The flat panel speaker of claim 4, wherein the bracket comprises a V-shaped bracket.

13. The flat panel speaker of claim 4 wherein the bracket comprises a T-shaped bracket.

14. The flat panel speaker of claim 1, wherein the flat panel comprises a projection screen of a rear-projection flat panel display.

15. The flat panel speaker of claim 1, wherein the flat panel comprises a protective element for a display.

16. The flat panel speaker of claim 1, wherein the flat panel comprises a filter for a computer screen.

17. The flat panel speaker of claim 4, further comprising:
a plurality of brackets attached to the flat panel; and
a plurality of exciters mounted respectively on the plurality of brackets such that output surfaces of the exciters are oriented at non-zero angles relative to the major surface of the flat panel.

18. The flat panel speaker of claim 4, wherein the bracket comprises a material having a specific modulus greater than 10 Gpa/g/cm³.

19. The flat panel speaker of claim 18, wherein the bracket comprises a material having a specific modulus greater than 20 Gpa/g/cm³.

20. The flat panel speaker of claim 19, wherein the bracket comprises a material having a specific modulus greater than 90 Gpa/g/cm³.

21. The flat panel speaker of claim 20, wherein the bracket comprises a material having a specific modulus greater than 100 Gpa/g/cm³.

22. The flat panel speaker of claim 21, wherein the bracket comprises a material having a specific modulus greater than 200 Gpa/g/cm³.

23. A system comprising:
a flat panel speaker including a flat panel, and an exciter mounted to the flat panel such that an output surface of the exciter is oriented at a non-zero angle relative to a major surface of the flat panel; and
a driver unit electrically coupled to the exciter to drive the exciter.

24. The system of claim 23, the flat panel speaker further comprising a bracket, wherein the output surface of the exciter is mounted to the bracket and the bracket attaches to the flat panel.

25. The system of claim 24, wherein the bracket comprises an L-shaped bracket.

26. The system of claim 24, wherein the bracket defines a substantially U-shaped lip that mates with, an edge of the flat panel, wherein the edge of the flat panel attaches to the bracket in the U-shaped lip via an adhesive.

27. The system of claim 24, further comprising:
a plurality of brackets attached to the flat panel; and
a plurality of exciters mounted respectively on the plurality of brackets such that output surfaces of the exciters are oriented at non-zero angles relative to the major surface of the flat panel, wherein each of the exciters are electrically coupled to the driver unit.

28. The system of claim 24, wherein the bracket comprises a material having a specific modulus greater than 20 Gpa/g/cm³.

29. The system of claim 28, wherein the bracket comprises a material having a specific modulus greater than 1000 Gpa/g/cm³.

30. The system of claim 29, wherein the bracket comprises a material having a specific modulus greater than 200 Gpa/g/cm³.

31. The system of claim 23, wherein the driver unit comprises a power amplifier.

32. The system of claim 23, in the output surface of the exciter is mounted relative to the major surface of the flat panel at an angle of approximately 90 degrees.

33. A flat panel speaker comprising:
a flat panel;
an exciter defining an output surface; and
means for mounting the exciter on the flat panel such that the output surface of the exciter is oriented at a non-zero angle relative to a major surface of the flat panel.

34. The flat panel speaker of claim 33, wherein the means for mounting positions the output surface of the exciter at an angle between approximately 45 degrees and 135 degrees relative to the major surface of the flat panel.

35. The flat panel speaker of claim 33, wherein the means for mounting positions the output surface of the exciter at an angle approximately 90 degrees relative to the major surface of the flat panel.

36. A flat panel display system comprising:
a flat panel display screen,
a projection unit for projecting images on the flat panel display screen;
a bracket attached to the flat panel;
an exciter mounted on the bracket such that an output surface of the exciter is oriented at a non-zero angle relative to a major surface of the flat panel; and
a driver unit electrically coupled to the exciter to drive the exciter.

37. The flat panel display system of claim 36, wherein the output surface of the exciter is oriented relative to the major surface of the flat panel display screen at an angle of approximately 90 degrees.

38. The flat panel display system of claim 36, wherein the output surface of the exciter is mounted adjacent a first surface of the bracket and a second surface of the bracket attaches to the flat panel display screen.

39. The flat panel display system of claim 36, wherein the bracket attaches to the flat panel display screen near an edge of the flat panel display screen.

40. The flat panel display system of claim 39, wherein the bracket is a first bracket, the exciter is a first exciter and the non-zero angle is a first non-zero angle, the system further comprising:
a second bracket attached to the flat panel display screen near another edge of the flat panel display screen; and
a second exciter mounted on the second bracket such that an output surface of the second exciter is oriented at a second non-zero angle relative to the major surface of the flat panel.

41. The flat panel display system of claim 40, wherein the first and second non-zero angles are approximately 90 degrees.
